(19) United States
(12) Patent Application Publication
(10) Pub. No.: US 2009/0172656 A1
(43) Pub. Date: Jul. 2, 2009

(54) CIRCUIT DEVICE AND METHOD OF PROVIDING A PROGRAMMABLE POWER SUPPLY

(75) Inventors: D. Matthew Landry, Austin, TX (US); Phillip A. Callahan, Austin, TX (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Silicon Laboratories Inc., Austin, TX (US)

(21) Appl. No.: 11/967,850

(22) Filed: Dec. 31, 2007

(51) Int. Cl. G06F 9/44; G06F 9/00; G06F 9/30

(52) U.S. Cl. 717/173; 713/100; 712/226; 712/E09.016

(57) ABSTRACT

In a particular embodiment, a circuit device includes a plurality of network ports, power regulator circuitry coupled to the plurality of network ports, and a control input adapted to receive software updates. The circuit device further includes a memory adapted to store a plurality of instructions, including processor operating system instructions and an upgrade routine. The circuit device further includes a programmable processor that is coupled to the memory and to the control input. The programmable processor is adapted to receive software updates via the control input and to execute the upgrade routine to upgrade the processor operating system instructions to reprogram the programmable processor. Further, the programmable processor is adapted to control the power regulator circuitry to selectively provide a power supply to a network device via a selected network port of the plurality of network ports.

### FIELD OF THE DISCLOSURE

The present disclosure generally relates to a circuit device and method of providing a programmable power supply.

### BACKGROUND

Power over Ethernet (PoE), which is outlined in Institute of Electrical and Electronics Engineers (IEEE) Standard 802.3™-2005 clause 33 (the PoE Standard), refers to a technique for delivering power and data to an electronic device via Ethernet cabling. In a PoE system, a power sourcing equipment (PSE) device provides a power supply to electronic devices, which may be referred to as powered devices, via an Ethernet cable. PoE eliminates the need for a separate power source to deliver power to attached powered devices. Such powered devices may include voice over Internet protocol (VoIP) telephones, wireless routers, security devices, devices to monitor process control parameters, data processors, other electronic devices, or any combination thereof.

In general, a PSE device typically includes multiple network ports. Each of the multiple network ports includes a connector/adapter (such as an RJ-45 Ethernet connector) that is adapted to receive an Ethernet cable. The multiple network ports communicate data and optionally power to electronic devices that are coupled to the respective network ports. Conventionally, the PSE device includes a microcontroller having pre-defined power detection and power classification instructions to detect a Power over Ethernet (PoE) enabled device coupled to a particular network port and to determine a power classification associated with the PoE-enabled device. In some instances, conventional PSE devices may include features to allow for manual configuration of particular network ports, providing a level of configurability/programmability. However, such conventional PSE devices typically make extensive use of hardware control routines and do not include upgradable firmware. Unfortunately, if the PoE Standard changes to include new device detection schemes, new power classifications, or any combination thereof, such conventional PSE devices may need to be replaced with conforming PSE devices.

### SUMMARY

In a particular embodiment, a circuit device includes a plurality of network ports, power regulator circuitry coupled to the plurality of network ports, and a control input adapted to receive software updates. The circuit device further includes a memory adapted to store a plurality of instructions, including processor operating system instructions and an upgrade routine. The circuit device further includes a programmable processor that is coupled to the memory and to the control input. The programmable processor is adapted to receive software updates via the control input and to execute the upgrade routine to upgrade the processor operating system instructions to reprogram the programmable processor. Further, the programmable processor is adapted to control the power regulator circuitry to selectively provide a power supply to a network device via a selected network port of the plurality of network ports.

In another particular embodiment, a circuit device provides power and data to a network device via a network cable. The circuit device includes a network port adapted to communicate with a network device via a network cable, a power regulator circuit coupled to the network port, and a control input. The circuit device further includes a memory to store a plurality of instructions including power regulator circuit control instructions, processor operating instructions, and an upgrade routine. Additionally, the circuit device includes a processor that is coupled to the control input to receive software updates and that has access to the memory. The processor is adapted to execute the upgrade routine to upgrade the processor operating instructions, the power regulator circuit control instructions, or any combination thereof. The processor is adapted to execute the power regulator circuit control instructions to control the power regulator circuit to selectively provide a power supply to the network device via the network cable.

In still another particular embodiment, a method of providing a programmable power supply includes receiving replacement instructions at a control input of a network device. The network device includes a plurality of network ports, a control input, a processor, and a memory that is accessible to the processor. The memory stores a plurality of instructions that are executable by the processor to control operation of the processor and to control a power regulation circuit. The method further includes automatically replacing one or more instructions of the plurality of instructions in response to receiving the replacement instructions and providing a power supply to a powered device according to at least one of the replacement instructions via a selected network port of the plurality of network ports.

### BRIEF DESCRIPTION OF THE DRAWINGS

FIG. 1 is a block diagram of a particular illustrative embodiment of a Power over Ethernet (PoE) system including a power sourcing equipment (PSE) device adapted to provide a programmable power supply;

FIG. 2 is a block diagram of a second particular illustrative embodiment of a PoE system including a PSE/midspan circuit device adapted to provide a programmable power supply;

FIG. 3 is a diagram of a third particular illustrative embodiment of a PoE system including a PSE/midspan circuit device adapted to provide a programmable power supply;

FIG. 4 is a flow diagram of a particular illustrative embodiment of a method of providing a programmable power supply; and

FIG. 5 is a flow diagram of a second particular illustrative embodiment of a method of providing a programmable power supply.

### DETAILED DESCRIPTION OF ILLUSTRATIVE EMBODIMENTS

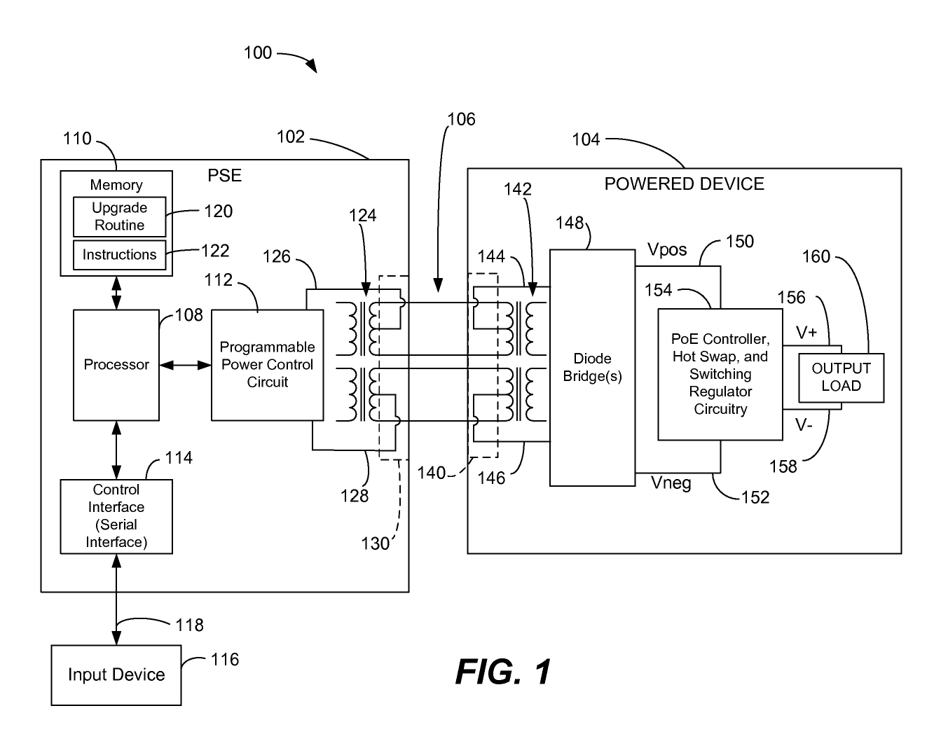

FIG. 1 is a block diagram of a particular illustrative embodiment of a Power over Ethernet (PoE) system 100 including a power sourcing equipment (PSE) device 102 that is adapted to provide a programmable power supply. The PSE device 102 is coupled to a powered device 104 via a network cable 106. In a particular embodiment, the network cable 106 is a category 5e (CAT-5e) Ethernet cable including multiple twisted-pair wires, which may be used to carry both power and data. The PSE 102 includes a processor 108 that is adapted to communicate with a memory 110. In a particular embodiment, the memory 110 may include both volatile memory (such as Random Access Memory (RAM), a cache memory, other volatile memory, or any combination thereof) and non-volatile memory (such as a flash memory, an erasable programmable read only memory (EPROM), other solid state memory, a hard disk, or any combination thereof). The memory 110 is adapted to store an upgrade routine 120 that is executable by the processor 108 to alter operating instructions, such as the instructions 122. In a particular embodiment, the instructions 122 may include operating system instructions that are executable by the processor 108 and the upgrade routine 120 may be executed by the processor to replace, append, or otherwise alter the operating system instructions.

The PSE device 102 further includes a control interface 114, which may include an inter-integrated circuit (I²C) interface, a serial peripheral interface (SPI), a universal serial bus (USB) interface, another interface, or any combination thereof. In a particular embodiment, the control interface 114 may include an Ethernet interface or network interface to receive commands and replacement instructions or software upgrades via a network. The control interface 114 receives commands, replacement instructions, software upgrades, and other data from an input device 116 via a cable 118. In a particular embodiment, the cable 118 is a serial cable. In another particular embodiment, the cable 118 is an Ethernet cable, which may allow the PSE device 102 to be reprogrammed remotely via a network, such as a private access network (not shown).

The PSE 102 also includes a programmable power control circuit 112 that is coupled to the processor 108. The programmable power control circuit 112 is coupled to a transformer circuit 124 via a first terminal 126 and a second terminal 128 to control a power supply that provided to the powered device 104 via the cable 106. In a particular embodiment, the processor 108 is adapted to control the programmable power control circuit 112 based on the instructions 122 stored at the memory 110.

The powered device 104 includes a transformer circuit 142 that is coupled to one or more diode bridges 148 via a first input terminal 144 and a second input terminal 146. In a particular embodiment, the cable 106 includes four or more wire pairs, and the powered device 104 may include multiple diode bridges 148 to rectify power received from the cable 106. The one or more diode bridges 148 receive a power supply via the first and second input terminals 144 and 146 and provide a positive power supply (Vpos) to a first power supply terminal 150 and a negative power supply (Vneg) to a second power supply terminal 152. The powered device 104 includes Power over Ethernet (PoE) controller, hot swap, and switching regulator circuitry 154 that is coupled to the first and second power supply terminals 150 and 152. The PoE controller, hot swap, and switching regulator circuitry 154 is adapted to identify a PoE device detection signal and to provide a responsive signal indicating that the powered device 104 is Power over Ethernet (PoE) enabled. In a particular embodiment, the PoE device detection signal is an applied voltage signal that is defined by the PoE Standard and the responsive signal is a current reflecting a particular resistance, such as approximately 25 kΩ. The PoE controller, hot swap, and switching regulator circuitry 154 is also adapted to respond to a PoE power classification signal received from the PSE device 102 by drawing a current associated with a particular power classification, which may be detected by the PSE device 102 to determine a power classification associated with the powered device 104. The PoE controller, hot swap, and switching regulator circuitry 154 is adapted to provide a switched power supply at a first load terminal 156 and at a second load terminal 158. An output load 160, such as a circuit device, is coupled to the first and second load terminals 156 and 158 to receive the switched power supply.

In a particular embodiment, the PSE device 102 uses the processor 108 to execute the instructions 122. The instructions 122 include Power over Ethernet (PoE) device detection instructions that are executable by the processor 108 to detect a powered device 104 coupled to the interface 130. Upon detection of the powered device 104, the processor 108 executes one or more of the instructions 122 to determine a power classification associated with the powered device 104. Once the PSE device 102 determines the power classification associated with the powered device 104, the processor 108 executes at least one instruction from the instructions 122 to control the programmable power control circuit 112 to provide a controlled power supply to the powered device 104 via the cable 106 according to the determined power classification.

In general, the processor 108 is a general-purpose processor that operates according to the instructions 122. The upgrade routine 120 allow for in-situ reprogramming of the processor 108 by replacing the instructions 122. The processor 108 is adapted to execute the reprogrammed instructions 122 to control the programmable power control circuit 112. In a particular embodiment, the processor 108 is adapted to control the programmable power control circuit 112 to perform device detection, device power classification, and power supply operations according to the PoE Standard. However, as the PoE Standard evolves to include modified detection and power classification schemes, the instructions 122 can be modified to alter the operation of the PSE device 102 to meet emerging standards without having to replace the processor 108 or the programmable power control circuit 112.

In a particular embodiment, instead of using fixed detection, classification, and power control (switch control) circuit blocks, the PSE device 102 uses a programmable processor 108 and a programmable power control circuit 112 that can be managed by the processor 108. In a particular embodiment, the instructions 122 may include processor firmware that can be overwritten by the input device 116 using the upgrade routine 120. By overwriting the firmware and making use of the programmable power control circuit 112, the PSE device 102 can be upgraded and/or reprogrammed to operate according to the current PoE Standard, emerging PoE Standards, other power/data standards, proprietary power standards, or any combination thereof.

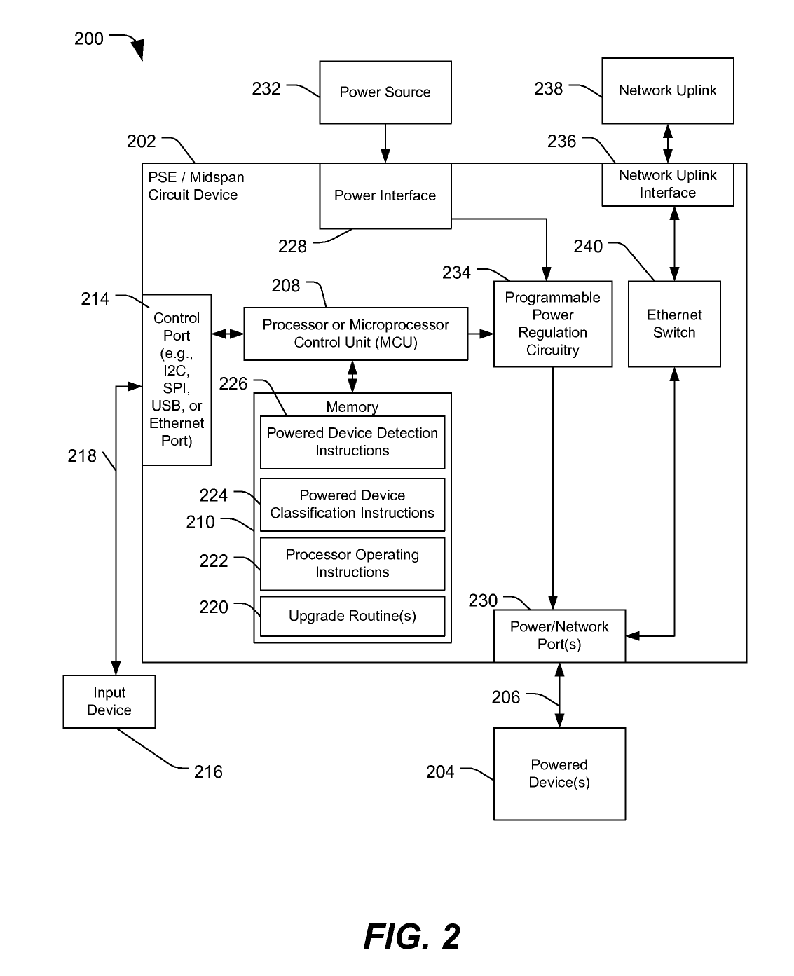

FIG. 2 is a block diagram of a second particular illustrative embodiment of a PoE system 200 including a PSE/midspan circuit device 202 that is adapted to provide a programmable power supply. In general, when the PSE/midspan circuit device 202 is installed as a hub or endpoint switch, it may be referred to as an endpoint device. Otherwise, if the PSE/midspan circuit device 202 is an intermediary device between a non-PoE capable switch and a PoE-enabled device, The PSE/midspan circuit device 202 can be referred to as a midspan device. The PSE/midspan circuit device 202 includes a processor or microprocessor control unit (MCU) 208 (“processor”) that communicates with a memory 210. The processor 208 is coupled to a control port 214 (such as an inter-integrated circuit (I²C) port, a serial peripheral interface (SPI) port, a universal serial bus (USB) port, an Ethernet port, another port, or any combination thereof). The control port 214 is coupled to an input device 216 via a cable 218. The input device 216 is adapted to provide replacement instructions, commands, upgraded software, or any combination thereof to the PSE/midspan circuit device 202 via the control interface 214. In a particular embodiment, the input device 216 is a computer, a personal digital assistant (PDA), a portable phone, another data processing device, or any combination thereof. In another particular embodiment, the input device 216 is a keyboard, an ASCII buffer device, another text input device, or any combination thereof. The PSE/midspan circuit device 202 is coupled to one or more powered devices 204 via one or more network cables 206.

The processor 208 is coupled to the memory 210. The memory 210 includes upgrade routines 220, processor operating instructions 222, powered device classification instructions 224, and powered device detection instructions 226. The upgrade routines 220 are executable by the processor 208 to alter or upgrade the processor operating instructions 222, the powered device classification instructions 224, the powered device detection instructions 226, or any combination thereof.

The PSE/midspan circuit device 202 also includes programmable power regulation circuitry 234 that is coupled to the processor 208, to one or more power/network ports 230, and to a power interface 228, which is coupled to a power source 232. The PSE/midspan device 202 also includes an optional Ethernet switch 240 that is coupled to the one or more power/network ports 230 and to a network uplink interface 236, which is connected to a network uplink 238. In a particular embodiment, the network uplink 238 may connect the PSE/midspan circuit device 202 to a local area network, a wide area network (such as the Internet), or any combination thereof.

In a particular embodiment, the processor 208 is adapted to execute the powered device detection instructions 226 to perform a device detection operation to detect a powered device 204 coupled to a particular port of the one or more power/network ports 230. Once a powered device 204 is detected, the processor 208 executes the powered device classification instructions 224 to determine a power classification associated with the detected powered device 204 from a plurality of power classifications. Each of the power classifications includes a respective power level that is to be delivered to the powered device 204. The processor 208 executes the processor operating instructions to control the programmable power regulation circuitry 234 to provide a power supply to the powered device 204 according to the determined power classification. In a particular embodiment, the PoE Standard defines the power classifications. In another particular embodiment, the power classifications are defined by another power/data standard. In still another particular embodiment, the power classifications may be customized for a particular implementation.

In a particular example, the PSE/midspan circuit device 202 is adapted to provide data to one or more powered devices 204 via the network uplink interface 236, the Ethernet switch 240 and the one or more power/network ports 230. Additionally, the PSE/midspan circuit device 202 is adapted to provide a power supply to one or more power devices 204 that are coupled to the one or more power/network ports 230 according to instructions stored at the memory 210. The processor 208 is adapted to control the programmable power regulation circuitry 234 to provide a respective power supply to each of the one or more powered devices 204 according to their respective power classifications. In a particular embodiment, the processor operating instructions 222, the powered device classification instructions 224, the powered device detection instructions 226, or any combination thereof can be altered or upgraded based on replacement instructions or software upgrades received via the control port 214. In response to receiving replacement instructions or software upgrades at the control port 214, the processor 208 is adapted to execute one or more of the upgrade routines 220 to selectively update the processor operating instructions 222, the powered device classification instructions 224, the powered device detection instructions 226, other instructions, or any combination thereof.

In a particular embodiment, the PSE/midspan circuit device 202 is programmable and is adapted to provide a programmable power supply to one or more powered devices 204 according to instructions stored at the memory. Additionally, in a particular embodiment, the processor 208 executes the processor operating instructions 222 to control the programmable power regulation circuitry 234. The processor operating instructions 222 can include instructions executable by the processor 208 to control a power supply to one or more powered devices 204 by sending control signals to the programmable power regulation circuitry 234. In a particular embodiment, the power classifications and power supply levels may be programmed. The processor 208 may receive upgrade software and/or replacement instructions related to power classifications and associated power supply levels via the control port 214, and in response to receiving the upgraded software and/or replacement instructions, the processor 208 executes the one or more upgrade routines 220 to update the processor operating instructions 222, the powered device classification instructions 224, the powered device detection instructions 226, or any combination thereof. Subsequently, the processor 208 is adapted to execute the processor operating instructions 222 to control the programmable power regulation circuitry 234 to provide a power supply according to levels defined by the upgraded software and/or replacement instructions.

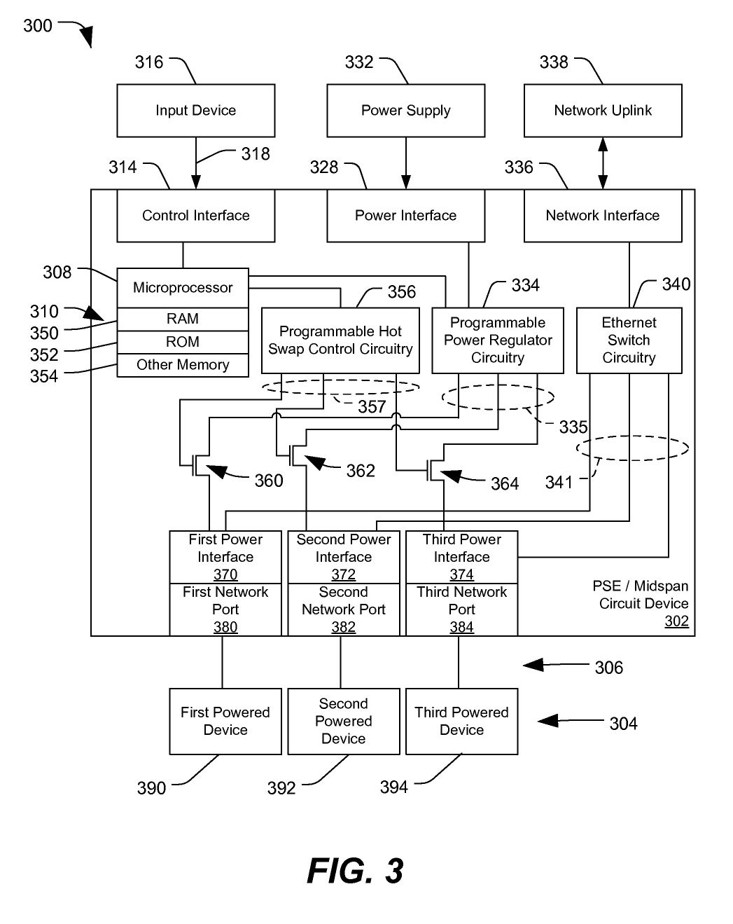

FIG. 3 is a diagram of a third particular illustrative embodiment of a PoE system 300 including a power sourcing equipment (PSE)/midspan circuit device 302 that is adapted to provide a programmable power supply. The PSE/midspan circuit device 302 is adapted to communicate power and data to one or more powered devices 304 via network cables 306. The PSE/midspan circuit device 302 includes a microprocessor 308 that communicates with a memory 310, which includes a random access memory (RAM) 350, a read only memory (ROM) 352, other memory 354, or any combination thereof. The ROM 352 can include an electrically erasable programmable ROM (EEPROM), a flash electrically erasable programmable ROM (flash EEPROM), other memory, or any combination thereof. In a particular embodiment, the ROM 352 is adapted to store firmware to control the operation of the microprocessor 308. The microprocessor 308 is coupled to a control interface 314 that is adapted to communicate with an input device 316 via a cable 318. In a particular embodiment, the control interface 314 may be a serial interface, such as an inter-integrated circuit (I²C) interface, a serial peripheral interface (SPI), a universal serial bus (USB) interface, another interface, or any combination thereof. In another particular embodiment, the control interface 314 receives data related to replacement instructions and/or software upgrades and provides the received data to the microprocessor 308. In still another particular embodiment, the ROM 352 or the other memory 354 includes an upgrade routine that is executable by the microprocessor 308 to alter the operating instructions.

The microprocessor 308 is coupled to programmable hot swap control circuitry 356 and to programmable power regulator circuitry 334. The programmable power regulator circuitry 334 is coupled to a power supply 332 via a power interface 328. The PSE/midspan circuit device 302 includes a first switch 360, a second switch 362, and a third switch 364. The first switch 360 includes a first drain terminal coupled to the programmable power regulator circuitry 334 via one of multiple power lines 335, a first control terminal coupled to the programmable hot swap control circuitry 356, and a first source terminal coupled to a first power interface 370. The second switch 362 includes a second drain terminal coupled to the programmable power regulator circuitry 334 via one of multiple power lines 335, a second control terminal coupled to the programmable hot swap control circuitry 356, and a second source terminal coupled to a second power interface 372. The third switch 364 includes a third drain terminal coupled to the programmable power regulator circuitry 334 via one of multiple power lines 335, a third control terminal coupled to the programmable hot swap control circuitry 356, and a third source terminal coupled to a third power interface 374. The first, second, and third switches 360, 362, and 364 are adapted to selectively couple the programmable power regulator circuitry 334 to the first, second, and third power interfaces 370, 372, and 374.

The PSE/midspan circuit device 302 further includes a first power interface 370 that is coupled to the first drain terminal of the first switch 360 and to a first network port 380, which is coupled to a first powered device 390. The PSE/midspan circuit device 302 also includes a second power interface 372 that is coupled to the second drain terminal of the second switch 362 and to a second network port 382, which is coupled to a second powered device 392. The PSE/midspan circuit device 302 further includes a third power interface 374 that is coupled to the third drain terminal of the third switch 364 and to a third network port 384, which is coupled to a second powered device 394. In a particular embodiment, the programmable hot swap control circuitry 356 is adapted to selectively activate the first, second, and third switches 360, 362 and 364 to selectively provide power to the first, second, and third powered devices 390, 392, and 394, respectively. The programmable power regulator circuitry 334 can be controlled by the microprocessor 308 to provide a power supply to the first, second and third power interfaces 370, 372, and 374 via the first, second, and third switches 360 according to a determined power classification for each of the first, second, and third powered devices 390, 392, and 394. In a particular embodiment, the microprocessor 308 controls the programmable power regulator circuitry 334 to apply a first voltage to the first drain of the first switch 360. The microprocessor 308 also controls the programmable hot swap control circuitry 356 to selectively activate the first switch 360 to allow current to flow through the first power interface 370 to the first network port 380.

The PSE/midspan circuit device 302 also includes an Ethernet switch 340 that is coupled to a network uplink 338 via a network interface 336 and that is coupled to the first, second, and third network ports 380, 382, and 384 via the first, second, and third power interfaces 370, 372, and 374 and via the data wires 341. In a particular embodiment, the PSE/midspan circuit device 302 is adapted to deliver power and data to the one or more powered devices 304 via the one or more network cables 306.

In a particular embodiment, the microprocessor 308 is programmable and is adapted to execute stored instructions to control the programmable hot swap control circuitry 356 and the programmable power regulator circuitry 334 to provide power to one or more powered devices 304 at one or more programmable power levels. In a particular example, the operation of the microprocessor 308 can be reprogrammed via replacement instructions and/or upgrade software received at the control interface 314. The microprocessor 308 is adapted to execute an upgrade routine to replace instructions stored in the ROM 352 or other memory 354. Further, the microprocessor 308 is adapted to execute the new instructions. The replacement instructions and/or upgraded software can include powered device detection instructions (such as the powered device detection instructions 226 illustrated in FIG. 2), powered device classification instructions (such as the powered device classification instructions 224 illustrated in FIG. 2), processor operating instructions (such as the processor operating instructions 222 illustrated in FIG. 2), or any combination thereof. In a particular embodiment, the upgraded software and/or the replacement instructions may be executable by the microprocessor 308 to perform device detection, device classification, and power delivery according to a revised Power over Ethernet standard, a customized standard, another standard, or any combination thereof. In a particular example, the upgraded software and/or replacement instructions may define new power levels, new device classifications, new detection schemes, or any combination thereof.

The PSE/midspan circuit device 302 includes a programmable microprocessor 308 that can be reprogrammed in situ (in system) during operation to provide new and/or additional functionality, additional power levels, other power schemes, or any combination thereof.

In general, the flexibility provided by the programmable microprocessor 308 and the PSE/midspan circuit device 302 allows the PSE/midspan circuit device 302 to be introduced early in a standardization process for the IEEE while allowing for evolution of the standard without concern that the standard will render the PSE/midspan circuit device 302 obsolete. In particular, the programmable microprocessor 308 can be reprogrammed to introduce new functionality in situ, allowing the PSE/midspan circuit device 302 to be reprogrammed to operate with existing standards, new standards, and/or custom (proprietary) power standards without having to replace the device hardware.

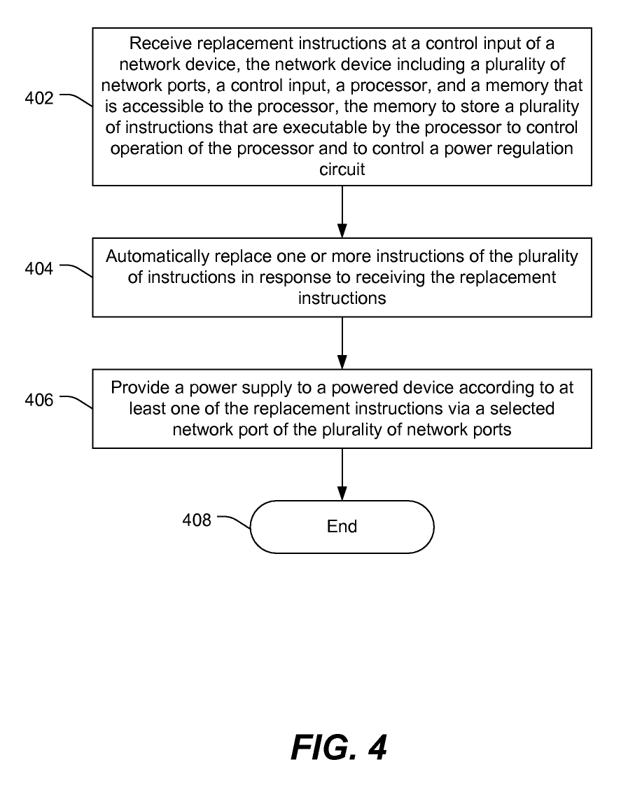

FIG. 4 is a flow diagram of a particular illustrative embodiment of a method of providing a programmable power supply. At 402, replacement instructions are received at a control input of a network device, where the network device includes a plurality of network ports, a control input, a processor, and a memory that is accessible to the processor. The memory is adapted to store a plurality of instructions that are executable by the processor to control operation of the processor and to control a power regulation circuit. Advancing to 404, one or more instructions of the plurality of instructions are automatically replaced in response to receiving the replacement instructions. In a particular embodiment, automatically replacing the one or more instructions includes replacing a first instruction to determine a power classification associated with the powered device from a first plurality of power classifications with a second instruction to determine the power classification associated with the powered device from a second plurality of power classifications. In a particular embodiment, the second plurality of power classifications is different from the first plurality of power classifications. In another particular embodiment, the second plurality of power classifications includes at least one power level that is greater than 15 watts. In still another particular embodiment, the second plurality of power classifications includes at least six power classifications. Moving to 406, a power supply is provided to the powered device according to at least one of the replacement instructions via a selected network port of the plurality of network ports. The method terminates at 408.

In a particular embodiment, the network device includes a power sourcing equipment (PSE) device adapted to supply power to the powered device via an Ethernet cable that is coupled to a network port of the plurality of network ports. In another particular embodiment, the PSE device is a midspan PSE device. In another particular embodiment, automatically replacing the one or more instructions includes performing an upgrade routine to reprogram the network device in situ.

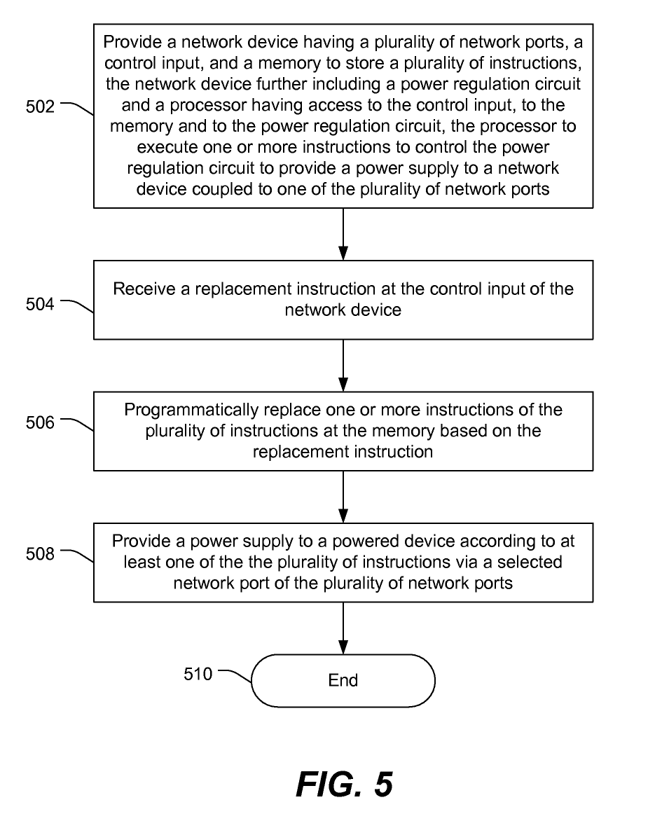

FIG. 5 is a flow diagram of a second particular illustrative embodiment of a method of providing a programmable power supply. At 502, a network device is provided that has a plurality of network ports, a control input, and a memory to store a plurality of instructions. The network device also includes a power regulation circuit and a processor having access to the control input, to the memory and to the power regulation circuit. The processor executes one or more instructions to control the power regulation circuit to provide a power supply to a network device coupled to one of the plurality of network ports. Advancing to 504, a replacement instruction is received at the control input of the network device. Continuing to 506, one or more instructions of the plurality of instructions are programmatically replaced at the memory based on the replacement instruction. For example, the replacement instruction may include upgraded software and the one or more instructions may be replaced with the upgraded software by executing an upgrade routine or program.

Moving to 508, a power supply is provided to a powered device via a selected network port of the plurality of network ports according to at least one of the plurality of instructions. In a particular embodiment, the plurality of instructions includes a power control instruction defining a plurality of power levels for a respective plurality of power classifications. The power supply may be provided to the powered device at a power level that is different from power levels defined by the PoE Standard based on the replacement instruction. The method terminates at 510.

Although the present specification describes components and functions that may be implemented in particular embodiments with reference to the PoE Standard (i.e., IEEE Std 802.3™-2005 clause 33), the disclosed embodiments are not limited to the PoE standard. For example, standards for Power over Ethernet and other power and data transmission techniques (such as broadband Internet over power lines) represent examples of power/data standards, where data and power are provided via a common cable. Standards, such as the PoE standard, are periodically updated with new standards that have similar functions. For example, the PoE standard may be replaced by a PoE plus (PoE+) standard that, among other modifications, allows for transmission of higher voltages, currents, power levels, or any combination thereof to powered devices that support such voltages, currents, power levels, or any combination thereof (i.e., PoE+ enabled devices). Accordingly, replacement standards and protocols having the same or similar functions as those disclosed herein are considered equivalents thereof. Embodiments of the PSE/midspan circuit devices illustrated in FIGS. 1-3 can be reprogrammed to adapt to changes to the PoE Standard or to implement other power/data standards.

Further, while the functionality described above is focused on Power over Ethernet, it should be understood that the programmable control of various circuit modules may be extended for use in other circuit devices where the market, the functionality, and the industry are continuing to evolve. In particular, the programmable processor and the associated circuitry may allow a commercial enterprise to enter a commercial market with non-standardized products while the market is still developing and without concern that the non-standardized products will be obsolete when a standard is adopted. In particular, the PSE/midspan devices described and illustrated with respect to FIGS. 1-3 may be updated to reflect changing and emerging standards and to introduce new functionalities to meet the needs of customers.

In general, the illustrated embodiments described herein are illustrative only and are used to provide a general understanding of the various embodiments. Other embodiments that utilize the functionality and methods described herein may be apparent to those of skill in the art in light of the present disclosure.

Although the present invention has been described with reference to preferred embodiments, workers skilled in the art will recognize that changes may be made in form and detail without departing from the spirit and scope of the invention.

What is claimed is:

1. A circuit device comprising:
a plurality of network ports;
power regulator circuitry coupled to the plurality of network ports;
a control input adapted to receive software updates; and
a memory adapted to store a plurality of instructions, the plurality of instructions including processor operating system instructions and an upgrade routine; and
a programmable processor coupled to the memory and to the control input, the programmable processor adapted to receive software updates via the control input and to execute the upgrade routine to upgrade the processor operating system instructions to reprogram the programmable processor, the programmable processor adapted to control the power regulator circuitry to selectively provide a power supply to a network device via a selected network port of the plurality of network ports.

2. The circuit device of claim 1, wherein the plurality of instructions further comprises powered device detection instructions that are executable by the programmable processor to detect the network device coupled to the selected network port.

3. The circuit device of claim 2, wherein the network device comprises a Power over Ethernet (PoE) enabled device.

4. The circuit device of claim 1, wherein the plurality of instructions further comprises powered device classification instructions that are executable by the programmable processor to determine a power classification associated with the network device that is coupled to the selected network port.

5. The circuit device of claim 4, wherein the power supply is selectively provided to the network device based on the determined power classification.

6. The circuit device of claim 1, wherein the control input comprises at least one of a serial peripheral interface, an inter-integrated circuit interface, and a universal serial bus (USB) interface.

7. A circuit device to provide power and data to a network device via a network cable, the circuit device comprising:
a network port adapted to communicate with a network device via a network cable;
a power regulator circuit coupled to the network port;
a control input;
a memory to store a plurality of instructions including power regulator circuit control instructions, processor operating instructions, and an upgrade routine; and
a processor coupled to the control input to receive software updates and having access to the memory, the processor adapted to execute the upgrade routine to upgrade the processor operating instructions, the power regulator circuit control instructions, or any combination thereof, the processor adapted to execute the power regulator circuit control instructions to control the power regulator circuit to selectively provide a power supply to the network device via the network cable.

8. The circuit device of claim 7, further comprising a hot swap control circuit coupled to the network port, the hot swap control circuit adapted to detect the network device via the network port.

9. The circuit device of claim 8, wherein the hot swap control circuit is adapted to selectively activate a switch in response to detecting the network device.

10. The circuit device of claim 7, wherein the power regulator circuit comprises a programmable power source.

11. The circuit device of claim 7, wherein the software updates include Power over Ethernet (PoE) device detection instructions that are executable by the processor to detect the network device.

12. The circuit device of claim 7, wherein the software updates include Power over Ethernet (PoE) power classification instructions that are executable by the processor to determine a power classification associated with the network device.

13. The circuit device of claim 7, wherein the upgrade routine is executable by the processor to replace or append to one or more of the plurality of instructions based on the software updates.

14. The circuit device of claim 7, wherein the processor is a general-purpose processor that is programmable via the upgrade routine.

15. The circuit device of claim 14, wherein the power regulator circuit control instructions include a plurality of programmable power levels associated with a respective plurality of power classifications, and wherein the power supply has a power level selected from the plurality of programmable power levels.

16. A method of providing a programmable power supply, the method comprising:
receiving replacement instructions at a control input of a network device, the network device including a plurality of network ports, a control input, a processor, and a memory that is accessible to the processor, the memory to store a plurality of instructions that are executable by the processor to control operation of the processor and to control a power regulation circuit;
automatically replacing one or more instructions of the plurality of instructions in response to receiving the replacement instructions; and
providing a power supply to a powered device according to at least one of the replacement instructions via a selected network port of the plurality of network ports.

17. The method of claim 16, wherein automatically replacing the one or more instructions comprises replacing a first instruction to determine a power classification associated with the powered device from a first plurality of power classifications with a second instruction to determine the power classification associated with the powered device from a second plurality of power classifications.

18. The method of claim 17, wherein the second plurality of power classifications is different from the first plurality of power classifications.

19. The method of claim 17, wherein the second plurality of power classifications includes at least one power level that is greater than 15 watts.

20. The method of claim 17, wherein the second plurality of power classifications includes at least six power classifications.

21. The method of claim 16, wherein the network device comprises a power sourcing equipment (PSE) device adapted to supply power to the powered device via an Ethernet cable that is coupled to a network port of the plurality of network ports.

22. The method of claim 16, wherein the network device comprises a midspan power sourcing equipment (PSE) device.

23. The method of claim 16, wherein automatically replacing the one or more instructions comprises executing an upgrade routine to reprogram the network device in situ.
